(19) United States
(12) Patent Application Publication
(10) Pub. No.: US 2009/0031406 A1
(43) Pub. Date: Jan. 29, 2009

(54) AUTHENTICATION INFORMATION PROCESSING DEVICE, AUTHENTICATION INFORMATION PROCESSING METHOD, STORAGE MEDIUM, AND DATA SIGNAL

(75) Inventor: Yoichi Hirose, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 12/052,097

(22) Filed: Mar. 20, 2008

(30) Foreign Application Priority Data
Jul. 26, 2007 (JP) 2007194155

(51) Int. Cl. H04L 9/32

(52) U.S. Cl. 726/7

(57) ABSTRACT

An authentication information processing device includes a receiving unit that receives an authentication request containing user identification information and a password from a terminal; an attack determination condition information storage unit that stores attack determination condition information for determining whether or not the received authentication request is made by an attacker; an attack determination unit that determines, by comparing the received authentication request and the attack determination condition information stored in the attack determination condition information storage unit, whether or not the authentication request is made by an attacker; and a transmission unit that transmits, when the attack determination unit determines that the authentication request is made by an attacker, input instruction information asking for input of an authentication request to the requesting terminal.

### CROSS-REFERENCE TO RELATED APPLICATIONS

This application is based on and claims priority under 35 USC 119 from Japanese Patent Application No. 2007-194155 filed on Jul. 26, 2007.

### BACKGROUND

1. Technical Field

The present invention relates to an authentication information processing device, an authentication information processing method, a storage medium, and a data signal.

2. Related Art

In general information systems having an authentication function, when the user wishes to use the system, the system receives an input of an authentication request which contains user identification information, such as a user ID, a user account, and so forth, and a password, and compares the input password and the password registered in advance in association with the input user identification information to determine whether or not to permit the user to use the system. Such an information system may be subjected to attack for illegal use by an attacker sending, for example, an authentication request a multiple number of times using different passwords and another user's account.

As related art for protecting the system from an attack such as an illegal access to thereby enhance system security, there is available a system for invalidating an account of a specific user when an authentication request containing that user account has failed more than a predetermined threshold number of times, for example. Such a system, however, may be subjected to an attack made by inputting a password a multiple number of times for the purpose of deliberately invalidating the user account of a particular user, rather than using the system.

In a system which invalidates a user account contained in an authentication request or shuts down the connection with a terminal having made an authentication request when an attack against the system is detected based on the number of times of authentication failure, generally, information indicating authentication failure is sent to the terminal having made the authentication request while informing the terminal of the content of the process carried out by the system against the attack. In the system sending such notification, the attacker can know the fact that the system detects the attack and also the content of the process carried out by the system to cope with the attack. Therefore, the above-described system sending a notice may give the attacker a chance to make an attack again against the system in the manner of countering the process carried out by the system to cope with the attack. For example, an attacker who knows that the user account is invalidated can make an attack using another user's account, and an attacker who knows that the terminal is disconnected can make an attack from another terminal.

### SUMMARY

According to one aspect of the invention, there is provided an authentication information processing device including a receiving unit that receives an authentication request containing user identification information and a password from a terminal; an attack determination condition information storage unit that stores attack determination condition information for determining whether or not the received authentication request is made by an attacker; an attack determination unit that determines, by comparing the received authentication request and the attack determination condition information stored in the attack determination condition information storage unit, whether or not the authentication request is made by an attacker; and a transmission unit that transmits, when the attack determination unit determines that the authentication request is made by an attacker, input instruction information asking for input of an authentication request to the requesting terminal.

### BRIEF DESCRIPTION OF THE DRAWINGS

Exemplary embodiments of the present invention will be described in detail based on the following figures, wherein:

FIG. 1 is a block diagram showing one example of a schematic structure of an information system having an authentication function;

FIG. 2 is a block diagram showing one example of a schematic structure of a server;

FIG. 3 is a diagram showing one example of data content of a terminal lock information DB;

FIG. 4 is a diagram showing one example of data content of an account lock information DB;

FIG. 5 is a diagram showing one example of data content of an NG password information DB;

FIG. 6 is a diagram showing one example of data content of an authentication failure information DB;

FIG. 7 is a block diagram showing one example of a part of a schematic structure of a server;

FIG. 8 is a diagram showing one example of data content of a user information DB;

FIG. 9 is a flowchart of one example of a procedure of an authentication process carried out by a server;

FIG. 10 is a diagram showing one example of a log-in form displayed on a terminal;

FIG. 11 is a diagram showing one example of another log-in form displayed on a terminal; and

FIG. 12 is a diagram showing one example of a hardware structure of a computer.

### DETAILED DESCRIPTION

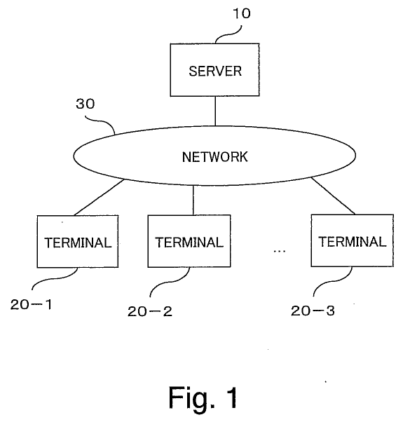

FIG. 1 is a block diagram showing one example of a schematic structure of an information system having an authentication function. In the system shown in FIG. 1, the server 10 is connected to terminals 20-1, 20-2, and so forth (hereinafter generally referred to as a terminal 20) via a network 30 such as the Internet, a local area network, and so forth.

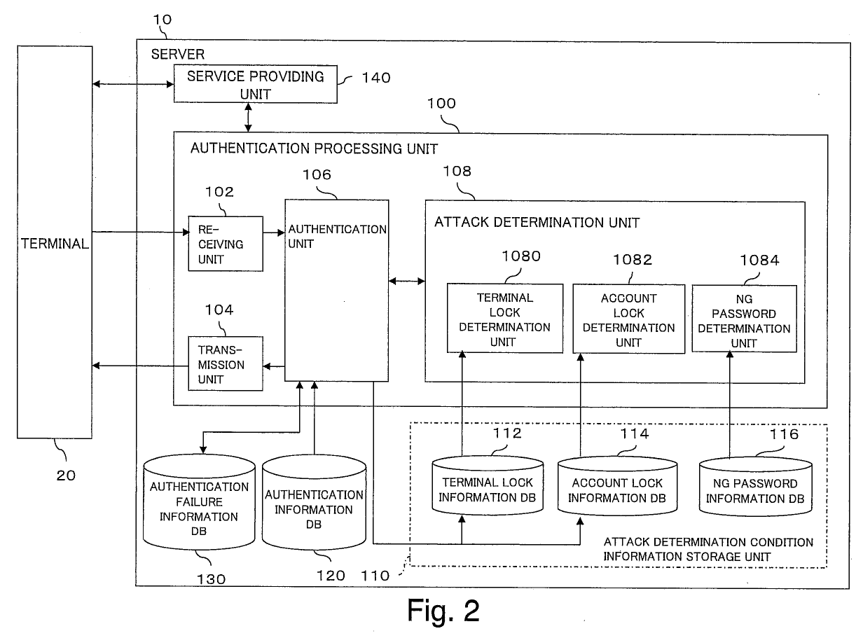

FIG. 2 shows one example of a schematic structure of the server 10. The server 10 functions as an authentication information processing device, or one exemplary embodiment of the present invention. The server 10 provides a service to a terminal 20 connected via a network in response to a service request sent from the terminal 20. The service to be provided by the server 10 includes, for example, provision of various information items (document data, image data, music data, motion picture data, and so forth, for example) stored in a memory device (not shown) connected to the server 10 to the terminal 20. The server 10 may also provide a service of storing various information items in a memory device (not shown) in response to a user instruction sent from the terminal 20.

The server 10 includes an authentication processing unit 100, an attack determination condition information storage unit 110, an authentication information DB (database) 120, an authentication failure information DB 130, and a service providing unit 140.

The authentication processing unit 100 receives an authentication request which contains a user ID (identifier) and a password, and determines whether or not to permit service provision to the user based on the received authentication request. The authentication processing unit 100 includes a receiving unit 102, a transmission unit 104, an authentication unit 106, and an attack determination unit 108.

The receiving unit 102 receives information such as an authentication request or the like sent from the terminal 20, and forwards the received information to the authentication unit 106. The transmission unit 104 sends authentication-related information to the terminal 20 according to an instruction from the authentication unit 106.

The authentication unit 106 carries out a process for authentication in response to an authentication request from the terminal 20, which is received via the receiving unit 102, while referring to the authentication information DB 120. Specifically, the authentication unit 106 determines whether or not to permit service provision to the terminal 20, based on the result of the authentication process, and notifies the service providing unit 140 of the result of the determination. In addition, the authentication unit 106 forwards the information concerning the authentication request received from the terminal 20 to the attack determination unit 108, and updates the information stored in the attack determination condition information storage unit 110 based on the result of the determination by the attack determination unit 108. The authentication unit 106 further determines the content of information to be sent to the terminal 20 based on the result of the authentication process and that of the determination by the attack determination unit 108, and sends the information via the transmission unit 104 to the terminal 20.

Specifically, the attack determination unit 108 compares the information concerning the authentication request, which is received from the authentication unit 106, and the information stored in the attack determination condition information storage unit 110 to determine whether or not the authentication request from the terminal 20 is made by an attacker. The attack determination unit 108 includes a terminal lock determination unit 1080, an account lock determination unit 1082, and an NG password determination unit 1084.

The terminal lock determination unit 1080 determines whether or not the requesting terminal 20 having requested for authentication is a lock target, while referring to the terminal lock information DB 112 in the attack determination condition information storage unit 110.

The account lock determination unit 1082 determines whether or not the user ID contained in an authentication request is an account lock target, while referring to the account lock information DB 114 in the attack determination condition information storage unit 110.

The NG password determination unit 1084 determines whether or not the password contained in an authentication request is an NG password which is possibly contained in an authentication request made by an attacker, while referring to the NG password information DB 116 in the attack determination condition information storage unit 110.

Details of the determinations made by the terminal lock determination unit 1080, account lock determination unit 1082, and NG password determination unit 1084 will be described later.

The attack determination condition information storage unit 110 is a storage unit for storing information for use in determination by the attack determination unit 108. The attack determination condition information storage unit 110 includes a terminal lock information DB 112, an account lock information DB 114, and an NG password information DB 116.

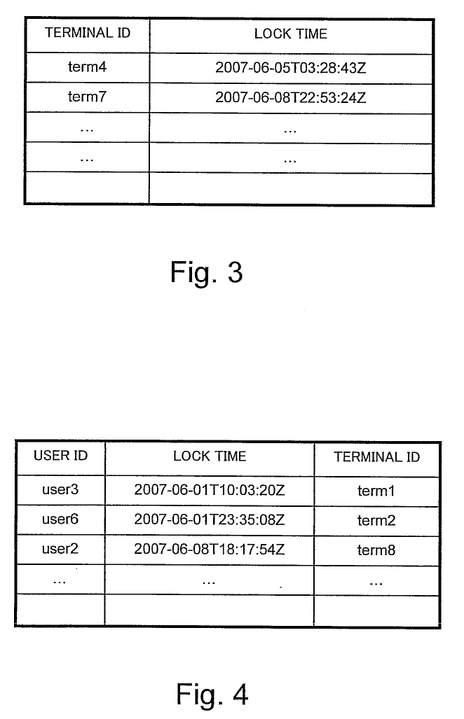

The terminal lock information DB 112 is a database for storing the terminal ID of a lock target terminal 20. A terminal ID is identification information unique to each terminal, including an IP (Internet Protocol) address, a MAC (Media Access Control) address, a device inherent ID, and so forth, for example. FIG. 3 shows one example of data content in the terminal lock information DB 112. In the table shown as an example in FIG. 3, a lock time at which a terminal 20 is registered as a lock target in the terminal lock information DB 112 is registered in association with the terminal ID of that lock target terminal 20. It should be noted that the lock time may not be registered if registration of a lock time is unnecessary in view of system management. Also, a flag which indicates whether or not a terminal 20 connected to the server 10 is a lock target may be registered in association with the terminal ID of that terminal 20 in the terminal lock information DB 112, instead of registering only the record of the terminal ID of that lock target terminal 20.

The account lock information DB 114 is a database for storing the user ID of an account lock target. FIG. 4 shows one example of data content of the account lock information DB 114. In the table shown in FIG. 4, a lock time at which the user ID is registered as an account lock target in the lock information DB 114, and the terminal ID of a terminal which last sends an authentication request which contains that user ID before that user ID is registered as an account lock target in the account lock information DB 114, are registered in association with the user ID of that account lock target. An item which is registered in the account lock information DB 114 in association with an account lock target user ID is not limited to a lock time and a terminal ID, shown as examples in FIG. 4, and any other item necessary for system management can be registered in association with the user ID, although, as long as the account lock target user ID is registered in the account lock information DB 114, another item is not mandatory. It should be noted that a flag which indicates whether or not the user ID of an authentic user registered in the system is an account lock target may be registered in the account lock information DB 114 in association with that user ID, in stead of registering only the record of the account lock target user ID.

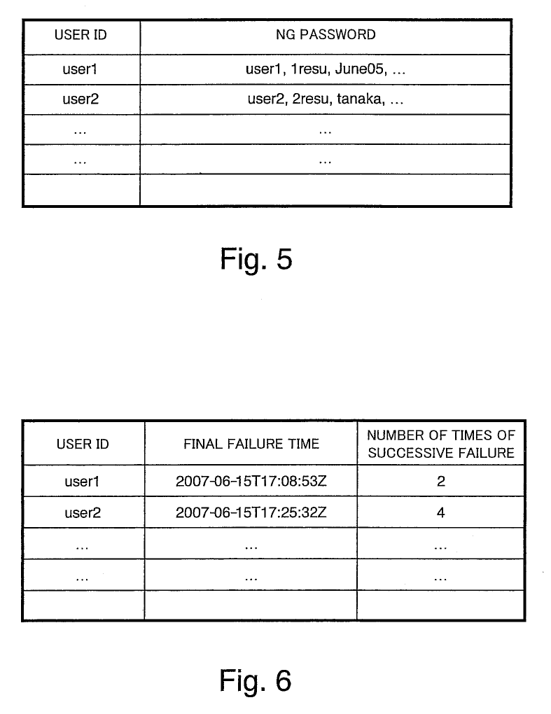

The NG password information DB 116 is a database for storing an NG password which is possibly contained in an authentication request made by an attacker. The NG password information DB 116 stores, for example, for a specific user, a password that is set as not used as a password of that user, as an NG password which is possibly contained in an authentication request made by an attacker. FIG. 5 shows one example of data content of the NG password information DB 116. In the table shown as an example in FIG. 5, an NG password set as not used as a password of a user is registered in association with the user ID of that user. The NG password registered in the NG password information DB 116 in association with a user ID is set based on, for example, the character string constituting the user ID or information about the user, or the owner of that user ID. For example, in FIG. 5, three NG passwords, namely, “user1”, “1resu”, and “June05”, are registered, segmented by “,”, as NG passwords in association with the user ID “user1”. The NG password “user1” is a password formed using the same character string as that of the user ID “user1”; the NG password “1resu” is a password formed using the character string of the user ID “user1” but arranged in the reverse order. The NG password “June05” is a character string indicating the birthday of the user, or the owner of the user ID “user1”. These NG passwords are only for illustration, and any character string may be set as an NG password according to a demand by the user, administrator, or information system which contains the server 10. Details of setting an NG password will be described later.

The authentication information DB 120 is a database for storing a user ID and a password in association with each other. The user ID registered in the authentication information DB 120 is the user ID of an authentic user to whom provision of a service by the server 10 is permitted.

The authentication failure information DB 130 is a database for storing information concerning an authentication request which results in authentication failure. FIG. 6 shows one example of data content of the authentication failure information DB 130. In the table shown as an example in FIG. 6, the authentication failure information DB 130 stores a final failure time and the number of times of successive failures resulting by that final failure time in association with a user ID, the final failure time being a time at which an authentication process carried out in response to an authentication-request containing that user ID fails last.

The data content of the authentication failure information DB 130 is not limited to the content shown as an example in FIG. 6. For example, a final failure time and the number of times of successive failures resulting by that final failure time may be registered in association with the pair of the user ID and terminal ID concerned, the final failure time being a time at which an authentication process carried out in response to an authentication request containing that user ID and sent from a terminal having that terminal ID fails last. Alternatively, a final failure time and the number of times of successive failures resulting by that final failure time may be registered in association with the concerned terminal ID, rather than the user ID, the final failure time being a time at which an authentication process carried out in response to an authentication request sent from a terminal having that terminal ID fails last.

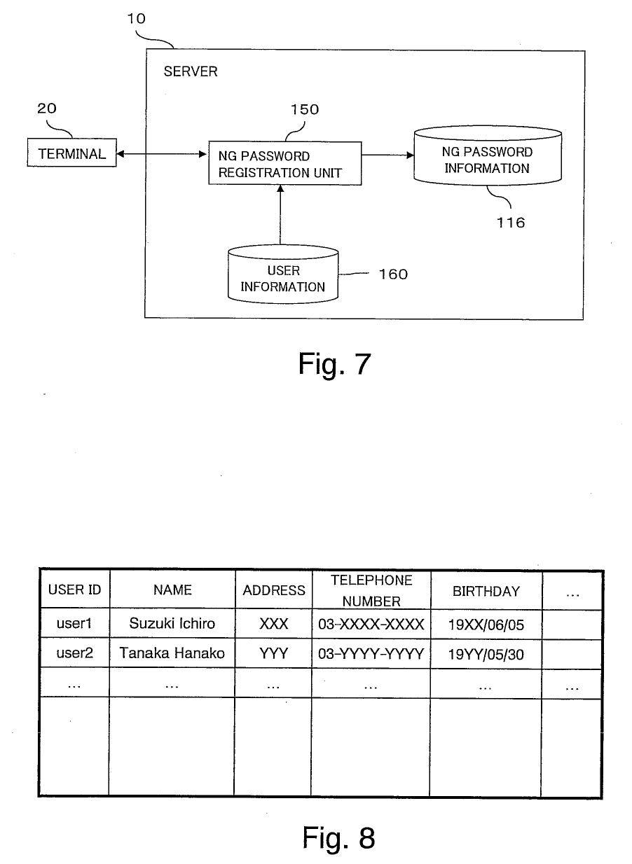

FIG. 7 is a block diagram showing one example of a structure of a function for registering an NG password in the NG password information DB 116 in the server 10. The structure shown as an example in FIG. 7 is realized in the server 10 having the authentication processing unit 100 shown as an example in FIG. 2. In FIG. 7, the server 10 includes an NG password registration unit 150, a user information DB 160, and an NG password information DB 116. The NG password information DB 116 corresponds to the database explained above while referring to FIGS. 2 and 5. Upon receipt of an instruction from a terminal, the NG password registration unit 150 produces a candidate for an NG password, and registers the NG password in the NG password information DB 116.

The user information DB 160 is a database for storing information about a user. FIG. 8 shows one example of data content of the user information DB 160. In the table shown as an example in FIG. 8, items concerning the user, including their name, address, telephone number, and birthday, are registered in association with the user ID of the user. The items shown in FIG. 8 are only examples, and these items need not be registered, and other items may be registered.

In the following, a registration process to be carried out by the NG password registration unit 150 will be described. Upon receipt of an instruction sent from the terminal 20 to register an NG password with designation of a user ID, the NG password registration unit 150 produces an NG password candidate, or a candidate for a password not used as a password of the user having the designated user ID, while referring to the user information DB 160. For example, an NG password candidate is produced using a character string which represents the content of an item registered in the user information DB 160 in association with the designated user ID. For example, all or a part of a character string representative of the content of an item, or all or a part of a character string representing the content of an item, but arranged in reverse order, is used as an NG password candidate. For example, when the content data shown as examples in FIG. 8 is registered in the user information DB 160 and the user ID “user1” is designated, “suzukiichiro”, “suzuki”, “ichiro”, “orihciikuzus”, “ikuzus”, “orihci”, and so forth, are produced as NG password candidates using the character string of the name, or “Suzuki Ichiro”, which is registered in association with the user ID “user1”, or a part thereof. Also, character strings (or a part thereof) representative of the content of the multiple items registered in association with the designated user ID, for example, may be combined to produce an NG password candidate. For example, a part of the character string of the name “Suzuki Ichiro” for the user ID “user1” can be combined with a part of the character string representative of the birthday “19XX/06/05” to produce an NG password candidate, “suzuki0605” and so forth.

Also, for example, the character string representative of the designated user ID itself or the character string thereof but arranged in reversed order may be used as NG password candidates.

The NG password registration unit 150 sends the produced NG password candidate to the terminal 20 to be displayed in order to receive selection by the operator (system user or administrator, for example) of the terminal 20. Thereafter, the NG password candidate selected by the operator is registered in the NG password information DB 116 in association with the designated user ID.

Instead of producing an NG password candidate based on the designated user ID and information stored in the user information DB 160, the NG password registration unit 150 may receive input of an NG password from the user and store the input NG password in association with the user ID of the user in the NG password information DB 116. For example, the user may input as an NG password a character string representative of the name of their family, pet, hobby, favorite, and so forth.

Alternatively, all of the NG password candidates produced based on the designated user ID and information stored in the user information DB 160 may be registered, instead of registering only those selected by the operator of the terminal 20, in association with the designated user ID in the NG password information DB 116.

It should be noted that although the server 10 having the authentication processing unit 100 (FIG. 2) has the structure shown as an example in FIG. 7 in the above description, in another example, the structure shown as an example in FIG. 7 may be realized in a server different from the server 10 having the authentication processing unit 100. In this case, after the above-described NG password is registered, the information registered by the NG password registration unit 150 in the NG password information DB 116 is stored in the NG password information DB 116 of the server 10 having the authentication processing unit 100 via a movable storage medium such as CD and DVD or communication means such as a network. With the above, the authentication processing unit 100 can utilize the information registered by the NG password registration unit 150.

In the following, a process to be carried out in the server 10 in response to a service request from the terminal 20 asking for provision of a service will be described.

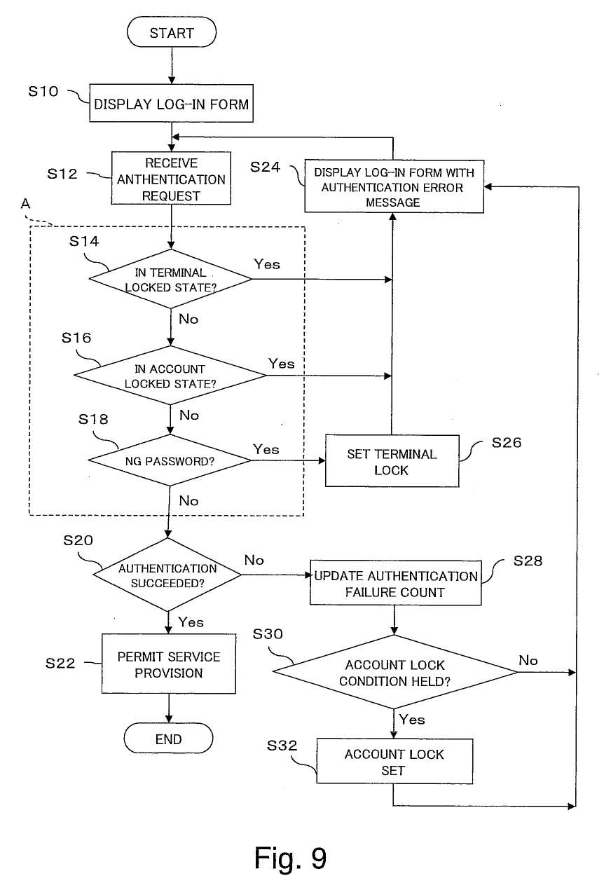

With a service request from the terminal 20 to the server, the service providing unit 140 notifies the authentication processing unit 100 of the reception of the service request. The authentication processing unit 100 having been notified by the service providing unit 140 of the receipt of a service request begins a process of the procedure shown in FIG. 9, for example. The process step in the broken square line A in FIG. 9 corresponds to the process to be carried out by the attack determination unit 108 of the authentication processing unit 100.

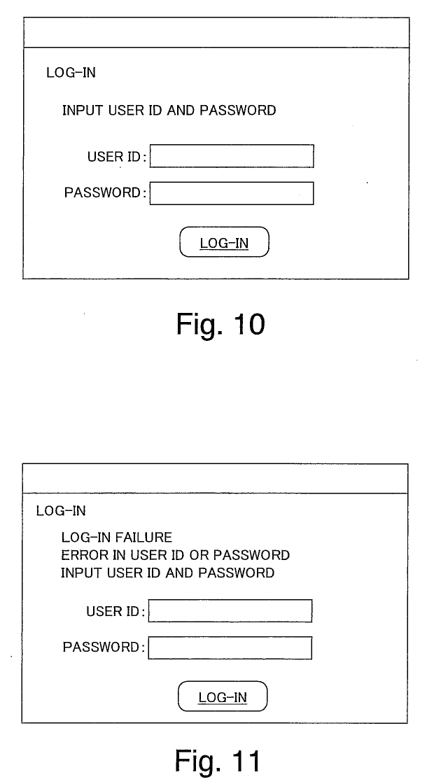

While referring to FIG. 9, at step S10, the authentication processing unit 100 initially sends information asking for input of a user ID and a password to the terminal 20 having requested a service (hereinafter referred to as a “requesting terminal 20”), via the transmission unit 104. The information to be sent here is information for displaying a log-in form, such as is shown in FIG. 10, on the requesting terminal 20, for example. With the log-in form such as is shown as an example in FIG. 10 displayed on the terminal, the user operating the requesting terminal 20 inputs their user ID and password. Then, the requesting terminal 20 sends an authentication request which contains the input user ID and password to the server 10.

At step S12, the receiving unit 102 receives the authentication request which contains the user ID and password from the requesting terminal 20, and forwards the received authentication request to the authentication unit 106. The authentication unit 106 forwards the authentication request and the terminal ID of the requesting terminal 20, both received from the receiving unit 102, to the attack determination unit 108. The terminal ID of the requesting terminal 20 is obtained via the network 30 connecting the terminal 20 and the server 10, for example.

The attack determination unit 108 having received the authentication request and the terminal ID of the requesting terminal 20 from the authentication unit 106 initially carries out a process by the terminal lock determination unit 1080 at step S14 to determine whether or not the requesting terminal 20 is a lock target. At step S14, the terminal lock determination unit 1080, with reference to the terminal lock information DB 112, determines that the requesting terminal 20 is in a locked state when the terminal ID of the requesting terminal 20 is registered as a lock target in the terminal lock information DB 112 and the period of time elapsed from the lock time recorded in association with the terminal ID of the requesting terminal 20 to the current time is equal to or smaller than a predetermined threshold. The threshold of the period of time elapsed is set between one to twenty-four hours, for example, depending on the security level of the system. Meanwhile, when the terminal ID of the requesting terminal 20 is not registered as a lock target in the terminal lock information DB 112 or when the period of time elapsed after the lock time registered in association with that terminal ID to the current time exceeds a predetermined threshold even though the terminal ID of the requesting terminal 20 is registered as a lock target in the terminal lock information DB 112, the terminal lock determination unit 1080 determines that the requesting terminal 20 is not in a locked state.

Alternatively, in the determination at step S14, the terminal lock determination unit 1080 may determine that the requesting terminal 20 is a lock target when the terminal ID of the requesting terminal is registered in the terminal lock information DB 112, without referring to the lock time for each terminal ID, recorded in the terminal lock information DB 112, and that the requesting terminal 20 is not a lock target when the terminal ID is not registered. In this case, for example, the authentication unit 106 may check the lock time of each terminal ID, recorded in the terminal lock information DB 112, at a constant time interval (24 hours, for example), separately from the process of the procedure shown as an example in FIG. 9, and delete the terminal ID from the terminal lock information DB 112 (that is, the terminal is released from the lock state) when a period of time longer than a predetermined period of time has already elapsed from the lock time. In an arrangement in which the lock time is not used in the terminal lock determination (step S14), only a lock target terminal ID is registered in the terminal lock information DB 112, in which registration of the lock time of the terminal ID is unnecessary. With no lock time of a terminal ID registered, the terminal in a lock state can be released from that state in response to a process for deleting all terminal IDs of terminals registered as lock targets in the terminal lock information DB 112, which is carried out at a predetermined time interval, or a process for deleting the terminal ID designated by the system manager from the terminal lock information DB 112, which is carried out at a timing designated by the system manager.

Upon determination at step S14 that the requesting terminal 20 is a lock target, the attack determination unit 108 notifies the authentication unit 106 of the determination result before the process proceeds to step S24. This means that the attack determination unit 108 has concluded that the authentication request has been made by an attacker.

At step S24, the authentication unit 106 having been notified by the attack determination unit 108 that the requesting terminal 20 is in a locked state sends information indicating authentication failure and asking for input of the user ID and password to the requesting terminal 20. Specifically, information for displaying a log-in form with an authentication error message, such as is shown in FIG. 11, on the requesting terminal 20 is sent at step S24. Alternatively, instead of displaying a log-in form with an authentication error message at step S24, a log-in form (the log-in form shown in FIG. 10, for example) similar to that displayed in the requesting terminal 20 at step S10 may be displayed. Displaying the log-in form similar to that which is displayed at step S10 on the requesting terminal 20 at step S24 results in displaying only a request to ask for input of the user ID and password again, without letting the user of the requesting terminal 20 know about the authentication failure. After step S24, the process returns to step S12.

When it is determined at step S14 that the requesting terminal 20 is not a lock target, the process proceeds to step S16.

At step S16, the attack determination unit 108 carries out a process by the account lock determination unit 1082 to determine whether or not the user ID contained in the authentication request is in an account locked state. At step S16, the account lock determination unit 1082 with reference to the account lock information DB 114 determines that the user ID contained in the authentication request is in an account locked state when that user ID is registered as an account lock target in the account lock information DB 114, and that the user ID is not in an account locked state when that user ID is not registered.

Upon determination made at step S16 to the effect that the user ID contained in the authentication request is in an account lock state, the attack determination unit 108 notifies the authentication unit 106 of the determination result before the process proceeds to step S24. This means that the attack determination unit 108 has concluded that the authentication request has been made by an attacker. The authentication unit 106 having been notified that the user ID is in an account locked state carries out a process to display the above-described log-in form with an authentication error message at step S24 before the process returns to step S12.

Meanwhile, upon determination at step S16 that the user ID contained in the authentication request is not in an account locked state, the process proceeds to step S18.

At step S18, the attack determination unit 108 carries out a process by the NG password determination unit 1084 to determine whether or not the password contained in the authentication request is an NG password. Specifically, with reference to the NG password information DB 116, at step S18, the NG password determination unit 1084 determines that the password contained in the authentication request is an NG password when a password identical to the password contained in the authentication request is found among the NG passwords registered in association with the user ID contained in the authentication request. Meanwhile, the NG password determination unit 1084 determines that the password contained in the authentication request is not an NG password when there is no such password. At step S18, besides the case in which any NG password registered in the NG password information DB 116 in association with the user ID contained in the authentication request coincides completely with the password contained in the authentication request, the NG password determination unit 1084 may determine that the password contained in the authentication request is an NG password also in a case where the password contained in the authentication request contains any NG password registered in the NG password information DB 116.

Upon determination at step S18 that the password contained in the authentication request is an NG password, the attack determination unit 108 notifies the authentication unit 106 to that effect. This means that the attack determination unit 108 has concluded that the authentication request has been made by an attacker.

The authentication unit 106 having been notified that the password contained in the authentication request is an NG password, as determined at step S18, carries out a terminal lock setting process at step S26. Specifically, the authentication unit 106 registers the terminal ID of the requesting terminal and the current time (that is, a lock time) in association with each other in the terminal lock information DB 112.

After step S26, a log-in form with an authentication error message is displayed at step S24 before the process returns to step S12.

Meanwhile, when it is determined at step S18 that the password contained in the authentication request is not an NG password, the process proceeds to step S20. This means that all determinations made thus far by the attack determination unit 108 (steps S14, S16, and S18) have resulted in negative, or No. In other words, the attack determination unit 108 has concluded that the authentication request has not been made by an attacker.

At step S20, the authentication unit 106, while referring to the authentication information DB 120, carries out a process for authentication for the user ID and password contained in the authentication request. Specifically, the authentication unit 106 initially determines whether or not the user ID contained in the authentication request is registered in the authentication information DB 120, and determines authentication failure when the user ID is not registered in the authentication information DB 120. Meanwhile, when the user ID contained in the authentication request is registered in the authentication information DB 120, the password contained in the authentication request is compared with the password registered in the authentication information DB 120 in association with the user ID. Successful authentication is determined when these coincide with each other, while authentication failure is determined when these do not coincide with each other.

With successful authentication determined at step S20, the process proceeds to step S22. At step S22, the authentication processing unit 100 notifies the service providing unit 140 of permission for service provision. The service providing unit 140 having received the notice of permission for service provision from the authentication processing unit 100 provides a service according to the service request from the terminal.

Meanwhile, with authentication failure determined at step S20, the process proceeds to step S28, where the authentication unit 106 updates the information stored in the authentication failure information DB 130. In the following, a process to be carried out when the data having the content shown as an example in FIG. 6 is stored in the authentication failure information DB 130 will be described as an example of an update process to be carried out at step S28. Initially, the authentication unit 106 searches for a user ID identical to the user ID contained in the authentication request among those registered in the authentication failure information DB 130. When there is one identical to the user ID contained in the authentication request in the authentication failure information DB 130, the final failure time stored in associated with the user ID is compared with the current time, and when the period of time elapsed from the final failure time to the current time is within a predetermined threshold (thirty minutes, for example), the final failure time is replaced by the current time, and the number of times of successive failure recorded in association with the user ID is incremented by one. Meanwhile, when the period of time elapsed from the final failure time to the current time is in excess of the predetermined threshold, the number of times of successive failure recorded in association with the user ID is replaced by “one”, and the final failure time is replaced by the current time. Meanwhile, when there is no user ID identical to the user ID contained in the authentication request registered in the authentication failure information DB 130, that user ID is newly registered in the authentication failure information DB 130, and the current time is recorded as the final failure time in association with the newly registered user ID, with the number of times of successive failure therefor set as “one”.

After the process at step S28, the authentication unit 106, while referring to the authentication failure information DB 130, determines at step S30 whether or not an account lock condition is held. The account lock condition is a condition used in determining whether or not to lock the account of a specific user ID, and it is determined, for example, that an account of a specific user ID should be locked when a process for authentication made in response to an authentication request containing that use ID fails more than a predetermined number of times within a predetermined period of time. For example, for an arrangement in which the data having the content shown as an example in FIG. 6 is registered in the authentication failure information DB 130, and the process described above with reference to FIG. 6 is carried out in the update process at step S28, a condition “the number of times of successive failure is equal to or larger than a predetermined threshold (six times, for example)” can be set as an account lock condition. In this example, the account of the user ID is locked when the number of successive failures exceeds a predetermined number of times within the period of the elapsed time threshold defined at step S28, that is, the account lock condition is satisfied.

A parameter for defining an account lock condition, such as the threshold for the elapsed time and the threshold for the number of times of successive failure in updating at step S28, for example, can be set for every user. For example, with an arrangement in which a parameter for defining an account lock condition is registered in association with each user ID in the authentication information DB 120 or authentication failure information DB 130, by performing condition determination using the parameter registered in association with the user ID contained in the authentication request, it is possible to determine whether or not to lock a particular account based on a different condition depending on the user.

It should be noted that a method for the update process at step S28 and account lock condition determination at step S30 is not limited to the above-described example. For example, instead of storing a final failure time in association with the user ID in the authentication failure information DB 130, a time at which the number of times of successive failure is set as one (a counting start time) may be recorded so that the number of times of successive failure is incremented by one in the update at step S28 when the period of time elapsed after the counting start time to the current time is within a predetermined threshold. Meanwhile, the number of times of successive failure is replaced by one and the counting start time is then replaced by the current time when the period of time elapsed is in excess of a predetermined threshold.

When it is determined at step S30, that the account lock condition is held, the authentication unit 106 carries out an account lock setting process at step S32. In the account lock setting process at step S32, the authentication unit 106 registers the user ID contained in the authentication request in the account lock information DB 114. The authentication unit 106 may register the current time (that is, a lock time), the terminal ID of the requesting terminal having requested for authentication, other information necessary for management, and so forth in the account lock information DB 114 in association with the user ID contained in the authentication request. After the process at step S32, the authentication unit 106 carries out a process to display the log-in form with an authentication error message described above at step S24 before the process returns to step S12.

Meanwhile, when it is determined at step S30 that the account lock condition is not held, the process proceeds to step S24, without carrying out the account lock setting process at step S32, where the authentication unit 106 carries out the above-described process to display the log-in form with an authentication error message before the process returns to step S12.

According to the process in the above described exemplary embodiment, in both of the cases where results of determinations by the attack determination unit 108 are positive, or Yes (process steps in the broken square line A, namely, steps S14, S16, and S18), and where authentication failure is determined at step S20, the same information for asking to display a log-in form with an authentication error message is sent to the requesting terminal 20 at step S24. Consequently, the attacker has no way of knowing what determination is made by the server 10 with respect to the authentication request from the requesting terminal 20 and what process is carried out as a result of the determination. The attacker knows only that they are not allowed to log-in, but cannot know that the server 10 has concluded that the authentication request from the terminal 20 has been made by an attacker.

Also, according to the process in this exemplary embodiment, a password which is highly likely to be input by an attacker and unlikely to be input by an authentic user is set as an NG password. Thus, even when a password which will result in authentication failure is input by an authentic attacker due to erroneous input of the password, for example, as long as the input password is not one of the NG passwords, the requesting terminal is not determined as a lock target as the NG password determination (steps S18) results in negative, or No.

It should be noted that in another example of the process to be carried out by the authentication processing unit 100, an account lock process (steps S16, S28, S30, and S32) may not be carried out in the process of the procedure shown as an example in FIG. 9.

Although the service providing unit 140 for providing a service in response to a service request from a terminal and the authentication processing unit 100 for determining whether or not to permit provision of a service are realized in a single server 10 in the above-described exemplary embodiment, the authentication processing unit 100 and the service providing unit 140 may be realized in respectively different servers in a different exemplary embodiment.

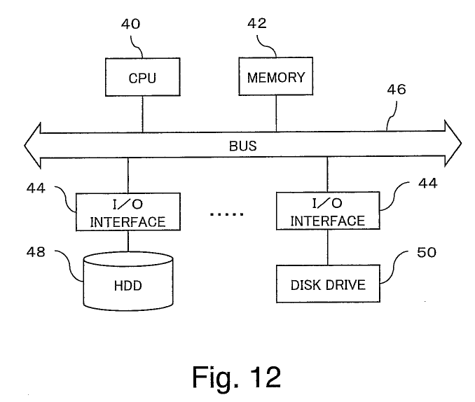

The server 10 shown as an example in the above is generally realized by executing a program which describes the functions of the respective units or process content on a general purpose computer. The computer has a circuit structure, as hardware, for example, in which a CPU (central processing unit) 40, a memory (primary memory) 42, various I/O (input/output) interfaces 44, and so forth are connected via a bus 46, as shown in FIG. 12. A disk drive 50 for reading a hard disk drive or a portable nonvolatile recording medium according to various standards, such as a CD, a DVD, a flash memory, or the like, is connected via an I/O interface 44, for example, to the bus 46. The drive 48 or 50 functions as an external memory device relative to the memory. A program which describes the process content in the exemplary embodiment is stored in a fixed memory device such as a hard disk drive 48 or the like via a storage medium such as a CD, a DVD, or the like or a network, and thus installed in the computer. The program stored in the fixed memory device is read and executed by the CPU, whereby the process in the exemplary embodiment is realized.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An authentication information processing device, comprising:
a receiving unit that receives an authentication request containing user identification information and a password from a terminal;
an attack determination condition information storage unit that stores attack determination condition information for determining whether or not the received authentication request is made by an attacker;
an attack determination unit that determines, by comparing the received authentication request and the attack determination condition information stored in the attack determination condition information storage unit, whether or not the authentication request is made by an attacker; and
a transmission unit that transmits, when the attack determination unit determines that the authentication request is made by an attacker, input instruction information asking for input of an authentication request to the requesting terminal.

2. The authentication information processing device according to claim 1, wherein
the attack determination condition information storage unit includes a terminal lock information storage unit that stores terminal identification information of a lock target terminal, and
the attack determination unit determines, when terminal identification information of the requesting terminal is stored in the terminal lock information storage unit, that the authentication request is made by an attacker.

3. The authentication information processing device according to claim 1, wherein
the attack determination condition information storage unit includes an unauthorized password information storage unit that stores an unauthorized password which is possibly contained in an authentication request made by an attacker,
the attack determination unit compares the password in the authentication request and the unauthorized password stored in the unauthorized password information storage unit to determine whether or not the authentication request is made by an attacker.

4. The authentication information processing device according to claim 2, wherein
the attack determination condition information storage unit further includes an unauthorized password information storage unit that stores an unauthorized password which is possibly contained in an authentication request made by an attacker,
the attack determination unit compares the password in the authentication request and the unauthorized password stored in the unauthorized password information storage unit to determine whether or not the authentication request is made by an attacker, and
the authentication information processing device further comprises a terminal lock information registration unit that registers, when the attack determination unit determines using the unauthorized password information storage unit that the authentication request is made by an attacker, terminal identification information of the requesting terminal in the terminal lock information storage unit.

5. The authentication information processing device according to claim 3, wherein
the unauthorized password information storage unit stores, as an unauthorized password, a password which is set as a password which is not used as a password of a user in association with user identification information of the user, and
the attack determination unit determines, when the password in the authentication request is included in the unauthorized password stored in the unauthorized password information storage unit in association with the user identification information in the authentication request, that the authentication request is made by an attacker.

6. The authentication information processing device according to claim 4, wherein
the unauthorized password information storage unit stores, as an unauthorized password, a password which is set as a password which is not used as a password of a user in association with user identification information of the user, and
the attack determination unit determines, when the password in the authentication request is included in the unauthorized password stored in the unauthorized password information storage unit in association with the user identification information in the authentication request, that the authentication request is made by an attacker.

7. The authentication information processing device according to claim 5, further comprising an unauthorized password registration unit that produces a candidate for the unauthorized password based on information concerning a user, and registers at least one of the candidate produced for the unauthorized password as the unauthorized password of the user in the unauthorized password information storage unit in association with the user identification information of the user.

8. The authentication information processing device according to claim 6, further comprising an unauthorized password registration unit that produces a candidate for the unauthorized password based on information concerning a user, and registers at least one of the candidate produced for the unauthorized password as the unauthorized password of the user in the unauthorized password information storage unit in association with the user identification information of the user.

9. A computer readable storage medium storing a program causing a computer to execute a process for processing authentication information, the process comprising:
receiving an authentication request containing user identification information and a password from a terminal;
storing, in an attack determination condition information storage unit, attack determination condition information for determining whether or not the received authentication request is made by an attacker;
determining, by comparing the received authentication request and the attack determination condition information stored in the attack determination condition information storage unit, whether or not the authentication request is made by an attacker; and
transmitting, when determined that the authentication request is made by an attacker, input instruction information asking for input of an authentication request to the requesting terminal.

10. The computer readable storage medium according to claim 9, wherein
the attack determination condition information storage unit includes an unauthorized password information storage unit that stores an unauthorized password which is possibly contained in an authentication request made by an attacker,
the unauthorized password information storage unit stores, as an unauthorized password, a password which is set as a password which is not used as a password of a user in association with user identification information of the user,
during the determining, when the password in the authentication request is included in the unauthorized password stored in the unauthorized password information storage unit in association with the user identification information in the authentication request, it is determined that the authentication request is made by an attacker, and
the process for processing authentication information further comprises,
producing a candidate for the unauthorized password based on information concerning a user, and
registering at least one of the candidate produced for the unauthorized password as the unauthorized password of the user in the unauthorized password information storage unit in association with the user identification information of the user.

11. The computer readable storage medium according to claim 9, wherein
the attack determination condition information storage unit includes a terminal lock information storage unit that stores terminal identification information of a lock target terminal, and an unauthorized password information storage unit that stores an unauthorized password which is possibly contained in an authentication request made by an attacker,
the unauthorized password information storage unit stores, as an unauthorized password, a password which is set as a password which is not used as a password of a user in association with user identification information of the user,
during the determining, when terminal identification information of the requesting terminal is stored in the terminal lock information storage unit, or when the password in the authentication request is included in the unauthorized password stored in the unauthorized password information storage unit in association with the user identification information in the authentication request, it is determined that the authentication request is made by an attacker, and
the process for processing authentication information further comprises,
registering terminal identification information of the requesting terminal in the terminal lock information storage unit, when it is determined, during the determining, using the unauthorized password information storage unit, that the authentication request is made by an attacker,
producing a candidate for the unauthorized password based on information concerning a user, and
registering at least one of the candidate produced for the unauthorized password as the unauthorized password of the user in the unauthorized password information storage unit in association with the user identification information of the user.

12. An authentication information processing method, comprising:
receiving an authentication request containing user identification information and a password from a terminal;
storing, in an attack determination condition information storage unit, attack determination condition information for determining whether or not the received authentication request is made by an attacker;
determining, by comparing the received authentication request and the attack determination condition information stored in the attack determination condition information storage unit, whether or not the authentication request is made by an attacker; and
transmitting, when determined that the authentication request is made by an attacker, input instruction information asking for input of an authentication request to the requesting terminal.

13. The method according to claim 12, wherein
the attack determination condition information storage unit includes an unauthorized password information storage unit that stores an unauthorized password which is possibly contained in an authentication request made by an attacker,
the unauthorized password information storage unit stores, as an unauthorized password, a password which is set as a password which is not used as a password of a user in association with user identification information of the user,
during the determining, when the password in the authentication request is included in the unauthorized password stored in the unauthorized password information storage unit in association with the user identification information in the authentication request, it is determined that the authentication request is made by an attacker, and
the method further comprises,
producing a candidate for the unauthorized password based on information concerning a user, and
registering at least one of the candidate produced for the unauthorized password as the unauthorized password of the user in the unauthorized password information storage unit in association with the user identification information of the user.

14. The method according to claim 12, wherein
the attack determination condition information storage unit includes a terminal lock information storage unit that stores terminal identification information of a lock target terminal, and an unauthorized password information storage unit that stores an unauthorized password which is possibly contained in an authentication request made by an attacker,
the unauthorized password information storage unit stores, as an unauthorized password, a password which is set as a password which is not used as a password of a user in association with user identification information of the user,
during the determining, when terminal identification information of the requesting terminal is stored in the terminal lock information storage unit, or when the password in the authentication request is included in the unauthorized password stored in the unauthorized password information storage unit in association with the user identification information in the authentication request, it is determined that the authentication request is made by an attacker, and
the method further comprises,
registering terminal identification information of the requesting terminal in the terminal lock information storage unit, when it is determined, during the determining, using the unauthorized password information storage unit, that the authentication request is made by an attacker,
producing a candidate for the unauthorized password based on information concerning a user, and
registering at least one of the candidate produced for the unauthorized password as the unauthorized password of the user in the unauthorized password information storage unit in association with the user identification information of the user.

15. A computer data signal embodied in a carrier wave for enabling a computer to perform a process for processing authentication information, the process comprising:
receiving an authentication request containing user identification information and a password from a terminal;
storing, in an attack determination condition information storage unit, attack determination condition information for determining whether or not the received authentication request is made by an attacker;
determining, by comparing the received authentication request and the attack determination condition information stored in the attack determination condition information storage unit, whether or not the authentication request is made by an attacker; and
transmitting, when determined that the authentication request is made by an attacker, input instruction information asking for input of an authentication request to the requesting terminal.

16. The computer data signal according to claim 15, wherein
the attack determination condition information storage unit includes an unauthorized password information storage unit that stores an unauthorized password which is possibly contained in an authentication request made by an attacker,
the unauthorized password information storage unit stores, as an unauthorized password, a password which is set as a password which is not used as a password of a user in association with user identification information of the user,
during the determining, when the password in the authentication request is included in the unauthorized password stored in the unauthorized password information storage unit in association with the user identification information in the authentication request, it is determined that the authentication request is made by an attacker, and
the process for processing authentication information further comprises,
producing a candidate for the unauthorized password based on information concerning a user, and
registering at least one of the candidate produced for the unauthorized password as the unauthorized password of the user in the unauthorized password information storage unit in association with the user identification information of the user.

17. The computer data signal according to claim 15, wherein
the attack determination condition information storage unit includes a terminal lock information storage unit that stores terminal identification information of a lock target terminal, and an unauthorized password information storage unit that stores an unauthorized password which is possibly contained in an authentication request made by an attacker, the unauthorized password information storage unit stores, as an unauthorized password, a password which is set as a password which is not used as a password of a user in association with user identification information of the user,
during the determining, when terminal identification information of the requesting terminal is stored in the terminal lock information storage unit, or when the password in the authentication request is included in the unauthorized password stored in the unauthorized password information storage unit in association with the user identification information in the authentication request, it is determined that the authentication request is made by an attacker, and
the process for processing authentication information further comprises,
registering terminal identification information of the requesting terminal in the terminal lock information storage unit, when it is determined, during the determining, using the unauthorized password information storage unit, that the authentication request is made by an attacker,
producing a candidate for the unauthorized password based on information concerning a user, and
registering at least one of the candidate produced for the unauthorized password as the unauthorized password of the user in the unauthorized password information storage unit in association with the user identification information of the user.
